(19) United States
(12) Patent Application Publication
(10) Pub. No.: US 2010/0039404 A1
(43) Pub. Date: Feb. 18, 2010

(54) INTEGRATED INPUT SYSTEM

(75) Inventors: Jao-Ching Lin, Taipei (TW); Lin-Abel Chu, Taipei (TW); Yen-Fu Liu, Taipei (TW); Chung-Yi Shen, Taipei (TW)

Correspondence Address: G. LINK CO., LTD, 3550 BELL ROAD, MINOOKA, IL, 60447, US

(73) Assignee: SENTELIC CORPORATION, Taipei (TW)

(21) Appl. No.: 12/193,055

(22) Filed: Aug. 18, 2008

(51) Int. Cl. G06F 3/045

(52) U.S. Cl. 345/174

(57) ABSTRACT

An integrated input system includes a touch sensing unit, a signal processing unit, a user instruction recognizing unit and an integration bus. The touch sensing unit has at least an electrical circuit and a transmission conducting line for outputting a sensing signal after being touched with one or multiple objects. The signal processing unit processes the sensing signal and outputting a press point message. The user instruction recognizing unit analyzes a user instruction, which includes a keyboard message input, a triggering action of a functional key or hot key, a directional input of a touchpad or mouse and a drawing information input of a handwriting board, corresponding to the press point message. The integration bus receives information of an external display unit and transmits the user instruction.

### BACKGROUND OF THE INVENTION

1. Field of the Invention

The present invention is related to a user instruction input system and particularly to an integrated input system with a single input interface for being applied to various portable electronic products conveniently.

2. Brief Description of the Related Art

The conventional input device of an electronic product includes the user instruction input device, which is capable of allowing the user interacting with the host, in addition to the disk drive, the optical disk drive and the memory card, which are capable of being read with the host of the electronic product. The user can input an instruction to the electronic product to amend the processing of electronic product directly via the user instruction input device. Generally speaking, the often employed input device are the keyboard for inputting the character and number information, the functional keys for triggering the special functions, the mouse for inputting the directional information, the locus ball, the touchpad or the writing board for inputting the handwritten figures.

Due to different input information, the principle applied with the input device and the structure of the input device are different from each other. Taking the traditional mechanical keyboard as an example, when the user presses a movable key, the touch-induced point under the key is triggered to urge the control chip of the keyboard to send the character or the numeric information corresponding to the touch-induced point to the keyboard transmission line and then the keyboard bus on the mainframe sends out the user instruction to various devices. Besides, the input devices with directional and the dragging movements on a window such as the mouse, the touchpad and the handwriting board are getting popular along with development of the window system. For instance, when the user touches the resistance type touchpad, the circuit at the two conductive films under the touchpad is short and the two-dimensional position of the press point can be figured out via the resistance representing the detected voltage value and the directional information can be transmitted to the host via the touchpad before the user instruction can be sent to various devices by the touchpad bus on the host.

Hence, the input devices with different operation systems have different control circuits for processing the signals thereof and even the bus provided on the host computer for receiving the signals is different from each other. However, for the most electronic products, not a single input device is used by an electronic product only. Taking the computer product as an example, the user needs the functional keys for triggering special functions, the mouse or the touchpad for directional inputs and the handwriting board for inputting the handwriting in addition to the keyboard for keying in the characters and the numbers. Adding one more input device requires various connecting lines, interface systems and spaces for being occupied by the connecting lines and the interface systems. Although the currently used portable electronic product such as the laptop computer has provided the keyboard 42, the functional keys 43 and the touchpad 41 as shown in FIG. 3, theses input devices are independent from each other and each of them has an input interface, a control circuit and a transmission line respectively such that a sufficient space for these components is still required.

Taiwan Patent No. 240050 entitled “A CAPACITANCE TYPE TOUCHPAD INTEGRATED WITH FUNCTIONS OF PRESS KEYS AND HANDWRITING” discloses a capacitance type touchpad, which is divided into a plurality of block zones, and the block zones are defined as key board input zones or directional input zones and a mode switch figure is provided for performing different input mode switches. However, a fixed area with the mode switch figure being touched to operate different mode switches is inconvenient especially for two modes being switched frequently, for instance, switching between the character-numeric input mode and the coordinate movement mode in the document editing program. Meanwhile, when the system is added with more and more modes or input interfaces, it is necessary to provide a large fixed area for the mode switch figure in order to operate the different input mode switches. Under this circumstance, other areas on the touchpad have to be diminished or a bigger sized touchpad has to be used instead. Even if the same zone is pressed multiple times to perform multiple switching, the user still has to operate repeatedly with reference to the user's manual in order to operate the desired input mode.

The preceding capacitance type touchpad combining the functions of press keys and handwriting instead of the conventional mechanical keyboard has achieved the purpose of the touchpad sensing the keyboard interface. However, the keyboard interface, the touchpad directional interface and even the functional key interface are operated independently with the individual mode switch. In this way, the whole dimension of the touchpad still provides the divided spaces, which are the same as the conventional multiple mode type touchpad. As a result, the preceding complicated mode switch is inconveniently operated to the user.

Hence, how to pursue an integrated input system, which is capable of joining all the user's input devices to a single input interface with multiple ways to recognize the user's operations is a goal worth us to care.

### SUMMARY OF THE INVENTION

In order to overcome the deficiencies of the preceding prior art, an integrated input system according to the present invention includes a touch sensing unit, a signal processing unit, a user instruction recognizing unit and an integration bus. The touch sensing unit has at least an electrical circuit and a transmission conducting line for outputting a sensing signal after being touched with one or multiple objects. The signal processing unit processes the sensing signal and outputs a press point message. The user instruction recognizing unit analyzes a user instruction, which includes a keyboard message input, a triggering action of a functional key or hot key, a directional input with a touchpad or mouse and a drawing information input of a handwriting board, to correspond to the press point message. The user instruction is outputted with the integration bus.

Wherein, the user instruction recognizing unit recognizes the user instruction corresponding to the press point message based on the feature of the press point or the prior press point message and user instruction such as a continuous press point message being regarded as the directional movement or dragging input of the mouse, a click press point message closely after the movement input of the mouse being regarded as a single tap of the mouse.

Besides, the external display unit information can be transmitted to the user instruction recognizing unit via the integration bus as a basis for recognizing the user instruction.

Nevertheless, the prior mode switch operation at the press point can be a basis for recognizing the user instruction. For instance, the click after triggering the keyboard input mode operation is regarded as keyboard message input and the click after triggering the touchpad input mode operation is regarded as a tap input of the directional operation.

An integrated input system according to the present invention further includes a mode switch triggering unit for triggering the operation of mode switch such as triggering the physical press key or triggering the specific zone on the touch sensing unit, or includes a switch action recognizing unit for recognizing the operation of the switch mode such as writing special characters, figures or gestures being regarded as a switch operation of a certain input mode to reach a fast switch instead of installing a switch key.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram illustrating an integrated input system according to the present invention;

FIG. 2 is a block diagram illustrating an integrated input interface according to the present invention; and

FIG. 3 is a perspective view illustrating the interface of the conventional lap top computer.

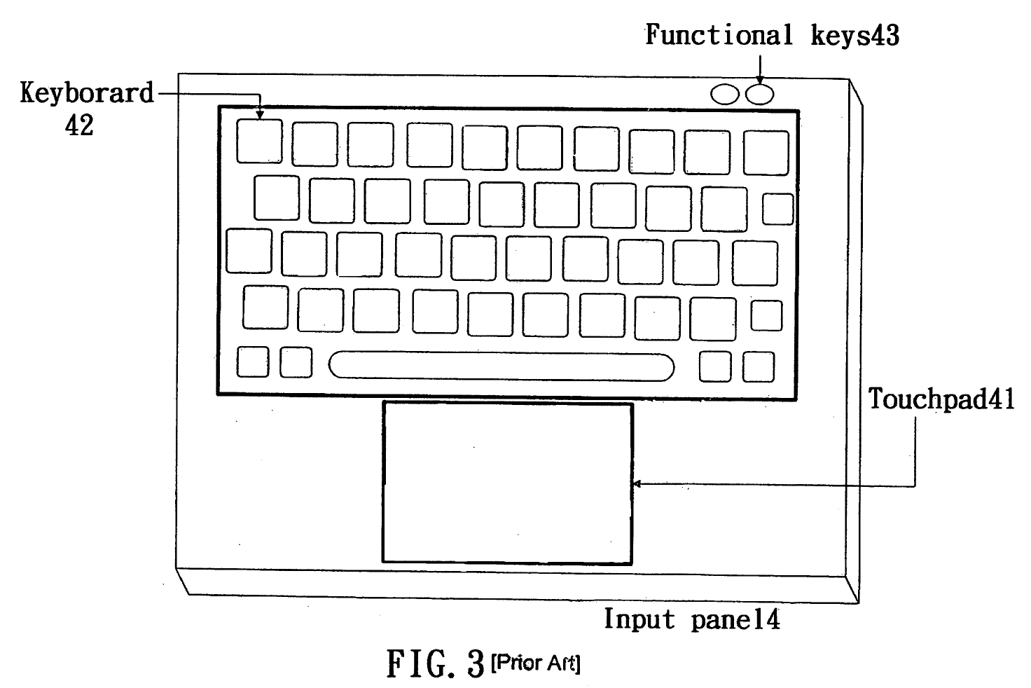

### DETAILED DESCRIPTION OF THE INVENTION

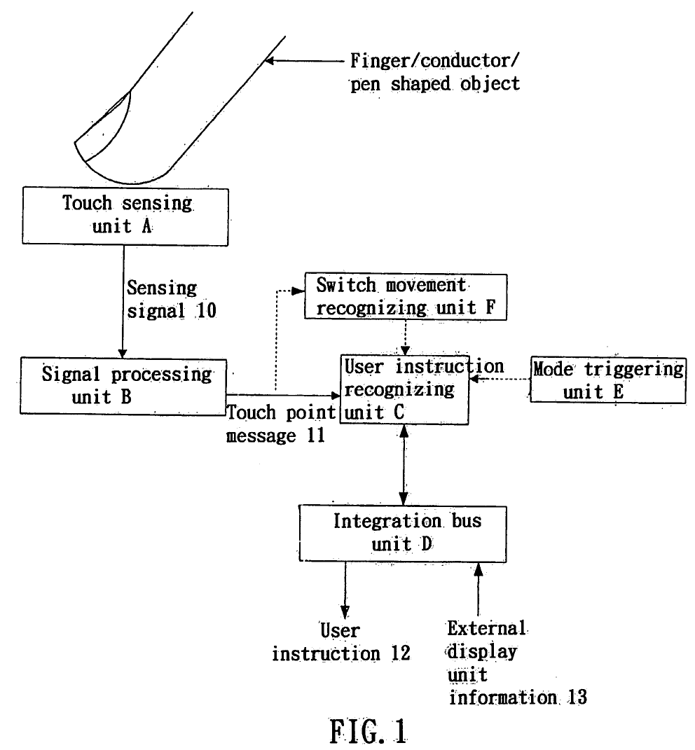

Referring to FIG. 1, an embodiment of an integrated input system includes a touch sensing unit A, a signal processing unit B, a user instruction recognizing unit C, an integrated bus unit D, a mode trigger unit E and a switching movement recognizing unit F. The mode trigger unit E, which further includes a or a plurality of physical press keys or a specific contact-trigger zone, is provided for being operated to switch different input modes. The result operated by the mode trigger unit E is connected to the user instruction recognizing unit C for recognizing the user instruction 12 corresponding to the touch point message 11, which is created via the touch sensing unit A being touched by an object such as a finger, a conductor or a pen to produce a sensing signal 10 and the sensing signal 10 then is processed by the signal processing unit B. In addition, the switch operation recognizing unit F is provided to analyze the mode operation corresponding to the touch point message 11 and then the result obtained from the mode switching is connected to the user instruction recognizing unit C for recognizing the user instruction 12 corresponding to the touch point message 11. The touch point message 11 includes a written special character or an operation of a figure, an operation of a special gesture, a contact to a special area and a plurality of contacts to a plurality of special areas.

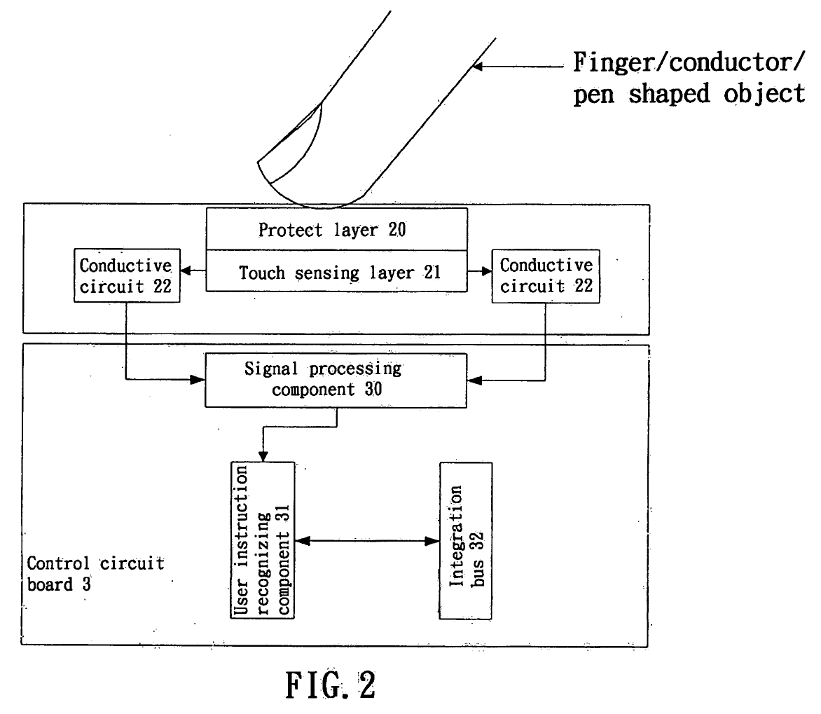

Besides, referring to FIG. 2, an integrated input interface according to the present invention includes a touch sensing board 2 and a control circuit board 3. The touch sensing board 2 further includes a protect layer 20, which is an insulation film with the upper surface thereof being touched with an object such as a finger, an conductor or a pen, a touch sensing layer 21, which provides an axis locus with a good conductivity and is disposed at the lower surface of the protect layer 20, and a conductive circuit 22, which is disposed at the periphery of the touch sensing layer for electrically connecting with the axis locus.

The control circuit board 3 further includes a signal processing component 30, which is connected to the conductive circuit 22 for processing a touch sensing signal produced by the touch sensing layer and outputting a touch point signal, an user instruction recognizing component 31, which is connected to the signal processing component for analyzing the touch point signal and recognizing the corresponding user instruction such as a keyboard input signal, an action of a functional key or hot key, a directional input of the touchpad or the mouse, a drawing information input of the hand writing board and inputs of other input interfaces, and an integrated bus 32, which is connected to the user instruction recognizing component 31 for outputting the user instruction and inputting information of an external display unit.

The axis locus on the touch sensing layer 21 can be two-dimensional dot distribution axis locus for outputting the sensing signal via the conductive circuit and the signal processing component analyzes the activated positions of the two-dimensional dot distribution locus. In this way, the position of the touch point and the touch movement can be obtained such as the one-dimensional drag and the scrolling.

Another embodiment of the touch sensing board 2 further includes a second axis locus and a conductive circuit for the second axis locus (not shown). The second axis locus is disposed opposite to the touch sensing layer via an insulation layer. The axis locus of the touch sensing layer intersects the second axis locus and is designated as the first axis locus. The first and second axis loci output the respective capacitance and the respective inductance sensing signal to the signal processing component via the respective conductive circuit such that the position of the touch point and the touch movement thereof can be obtained via the induced signals of the first axis locus and the second axis locus.

A further embodiment of the touch sensing board includes a lower conductive film and a conductive circuit. The lower conductive film is disposed opposite to touch sensing layer via a plurality of space dots and the touch sending layer, which is distributed with a high density, can be acted as an upper conductive film. While the touch point is pressed downward, the upper conductive film contacts with the lower conductive film to constitute a short circuit and the position of the touch point and touch movement can be figured out via the voltage difference exerted at two opposite sides of the upper conductive film.

Alternatively, a guiding light plate or an illuminant layer can be provided for the integrated input system of the present invention to illuminate the touch sensing board. Further, the protect layer 20 and the touch sensing layer 21 can be made of a part light-penetrable material such that the figure, the character or the partition line is illuminant. Meanwhile, a control component for the luminance can be provided to control the light source guided by the guiding light plate or the form of the luminance of the illuminant layer such as allowing the touch point being illuminant alone.

In order to allow the user having a physical press feeling while the keys are pressed, a three-dimensional relief design can be provided corresponding to the position of the keyboard or soft pads in different elasticity can be arranged in the touch sensing board.

The preceding input mode can be any of the standard input interfaces or an interface set by the user instead of the preceding the keyboard, the functional key, the touchpad or the handwriting board.

It is appreciated that the integrated input system of the present invention combines all the input devices or interfaces into a single input interface successfully such that the input device of the integrated input system is lighter, thinner and more flexible than the currently used input panel. Further, the input device of the present invention satisfies the integrated design such that the production cost and the assembly cost are much less with advantages of being water-proof, anti-shock and antistatic. Besides, the appearance of the input board has a novel shape instead of the conventional design, which is composed of three areas, the functional key zone, the keyboard zone and the touchpad zone.

While the invention has been described with referencing to the preferred embodiments thereof, it is to be understood that modifications or variations may be easily made without departing from the spirit of this invention, which is defined by the appended claims.

What is claimed is:

1. An integrated input system comprising:
a touch sensing unit, which has at least an electrical circuit and a transmission conducting line for outputting a sensing signal after being touched with one or multiple objects;
a signal processing unit, which processes said sensing signal and outputting a press point message;
a user instruction recognizing unit, which analyzes a user instruction, which includes a keyboard message input, an activated movement for a functional key or hot key, a directional input of a touchpad or mouse and a drawing information input of a handwriting board, corresponding to said press point message; and
an integration bus for receiving information of an external display unit and transmitting said user instruction.

2. The integrated input system as defined in claim 1, wherein said user instruction recognizing unit recognizes said user instruction.

3. The integrated input system as defined in claim 1, wherein said user instruction recognizing unit recognizes said user instruction based on a feature provided by said press point message.

4. The integrated input system as defined in claim 1, wherein said user instruction recognizing unit recognizes said user instruction based on a previous touch point message and a previous user instruction, which are performed prior to said touch point message.

5. The integrated input system as defined in claim 1, wherein said user instruction recognizing unit recognizes said user instruction based on a mode switch operation performed prior to said touch point message.

6. The integrated input system as defined in claim 5 further comprises a mode switching unit for triggering said switch operation between a physical key and a specific zone on said touch sensing unit.

7. The integrated input system as defined in claim 5 further comprises a switching action recognizing unit for recognizing and triggering said mode switch operation corresponding to said press point message and said press point message with a feature of writing a special character or drawing a pattern.

8. An integrated input interface comprising:
a touch sensing board; and
a control circuit;
wherein, said touch sensing board further comprises:
a protect layer, which is a film made of an insulation material for offering an upper surface of said touch sensing board an area for being touched with a or a plurality of objects;
a touch sensing layer being disposed at a lower surface of said protect layer and providing a first axis locus with good conductive rate; and
a first conductive circuit being disposed at the periphery of said touch sensing layer for conducting said axis locus;
and said control circuit further comprises:
a signal processing component connecting with said first conductive circuit for processing a touch sensing signal produced with said touch sensing layer and outputting a press point message;
a user instruction recognizing component being connected to said signal processing component for analyzing said press point message and recognizing a user instruction, which comprises a message input of a keyboard, a functional key (or hot key) triggering action and an input of drawing information of a handwriting board, corresponding to said press point message; and
an integration bus being connected to said user instruction recognizing component for outputting said user instruction and inputting information of an external display unit.

9. The integrated input interface as defined in claim 8, wherein said first axis locus is an axis locus distributed with two-dimensional dots to output a first capacitance sensing signal to said signal processing component via said first conductive circuit.

10. The integrated input interface as defined in claim 8 further comprises a second axis locus and a second conductive circuit being oppositely disposed to said touch sensing layer via an insulation layer and intersecting said first axis locus such that said second axis locus outputs a second capacitance sensing signal to said signal processing component.

11. The integrated input interface as defined in claim 8 further comprises a lower conductive film and a third conductive circuit being oppositely disposed to said touch sensing layer via a plurality of space dots; and said first axis locus is distributed with a high intensity and is regarded

12. The integrated input interface as defined in claim 11 further comprises a resistance calculation unit and a conductive film voltage source to connect with said first conductive circuit and said third conductive circuit respectively for figuring out a resistance sensing signal resulting from said upper conductive film contacting said lower conductive film and outputting said resistance sensing signal to said signal processing component.

13. The integrated input interface as defined in claim 8 further comprises a mode switch triggering component, which is a or a plurality of physical pressing keys or specific touch triggering zones, to be triggered to switch a plurality of different input modes individually with a triggered result being joined to said user instruction recognizing component for recognizing said user instruction.

14. The integrated input interface as defined in claim 8 further comprises a switching operation component for analyzing said mode switch operation with a mode switch result being joined to said user instruction recognizing component for recognizing said user instruction.

15. The integrated input interface as defined in claim 14, wherein said press point message comprises a or a plurality of special characters writings, a or a plurality of special pattern drawings, a or a plurality of special gestures, and a or a plurality of special zone touches.

16. The integrated input interface as defined in claim 8 further comprises a guiding light plate or an illuminant layer for illuminating said touch sensing board and allowing a part of said protect layer and said touch sensing layer.

17. The integrated input interface as defined in claim 16 further comprises an illumination control component for controlling a light source of said light guiding plate or a light emitting form of said illumination layer.

18. The integrated input interface as defined in claim 8 further comprises a soft pad providing a three-dimensional relief design corresponding to a position of said keyboard or providing a distribution with different elasticity for offering the same touch feeling as a physical press key.
